(19) United States
(12) Patent Application Publication
(10) Pub. No.: US 2010/0220673 A1
(43) Pub. Date: Sep. 2, 2010

(54) MOBILE STATION AND METHOD FOR DYNAMICALLY ADAPTING A GRANT INTERVAL DURING VOIP COMMUNICATIONS IN A BROADBAND WIRELESS NETWORK

(76) Inventors: Jie Hui, Portland, OR (US); Chunmei Liu, Great Falls, VA (US); Shweta Shrivastava, Beaverton, OR (US); Rath Vannithamby, Portland, OR (US)

Correspondence Address: SCHWEGMAN, LUNDBERG & WOESSNER/Intel, PO BOX 2938, MINNEAPOLIS, MN, 55402, US

(21) Appl. No.: 12/629,253

(22) Filed: Dec. 2, 2009

Related U.S. Application Data
(60) Provisional application No. 61/200,742, filed on Dec. 3, 2008.

(51) Int. Cl. H04W 8/00

(52) U.S. Cl. 370/329

(57) ABSTRACT

Embodiments of a mobile station and methods for dynamically adapting a grant interval during Voice-over-Internet Protocol (VoIP) communications in a broadband wireless network are generally described herein. The mobile station may detect a voice-state transition and may provide an indication to a base station to change a grant interval based on the detected voice-state transition. The base station dynamically adapts the grant interval based on the indication. Some embodiments utilize an adaptive granting and polling (aGP) service to dynamically adapt the grant interval based on the detected voice-state transition.

This application claims the benefit of priority under 35 U.S.C. 119(e) to U.S. Application Ser. No. 61/200,742, filed on Dec. 3, 2008, which is incorporated herein by reference in its entirety.

### TECHNICAL FIELD

Embodiments pertain to wireless communications. Some embodiments pertain to broadband wireless access networks. Some embodiments pertain to voice-over-internet protocol (VoIP) communications. Some embodiments pertain to on-line gaming.

### BACKGROUND

It is becoming more important to be able to provide telecommunication services to fixed and mobile subscribers as efficiently and inexpensively as possible. Further, the increased use of mobile applications has increased the need for wireless networks capable of delivering large amounts of data at high speed.

Development of more efficient and higher bandwidth wireless networks has become increasingly important and addressing issues of how to maximize efficiencies in such networks is ongoing. One such issue relates to efficient scheduling of transmissions and improving usage of bandwidth between nodes in a wireless network. In the case of VoIP communications, some conventional systems do not fully consider the on/off property of voice traffic when granting bandwidth.

Thus there are general needs for wireless networks, mobile communication devices, and methods that utilize bandwidth more efficiently.

### BRIEF DESCRIPTION OF THE DRAWINGS

FIG. 1 illustrates a portion of a broadband wireless access network, in accordance some embodiments;

FIGS. 2A and 2B illustrate adaptive grant operations, in accordance with some embodiments;

FIGS. 3A and 3B illustrate service specific bandwidth request header formats for adaptive grant operations, in accordance with some embodiments;

FIG. 4 illustrates a bandwidth request and uplink transmit power report header format for adaptive grant operations, in accordance with some embodiments;

FIG. 5 illustrates a bandwidth request and carrier to interference-plus-noise ratio report header format for adaptive grant operations, in accordance with some embodiments; and

FIG. 6 illustrates a bandwidth request and uplink sleep control header format for adaptive grant operations, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

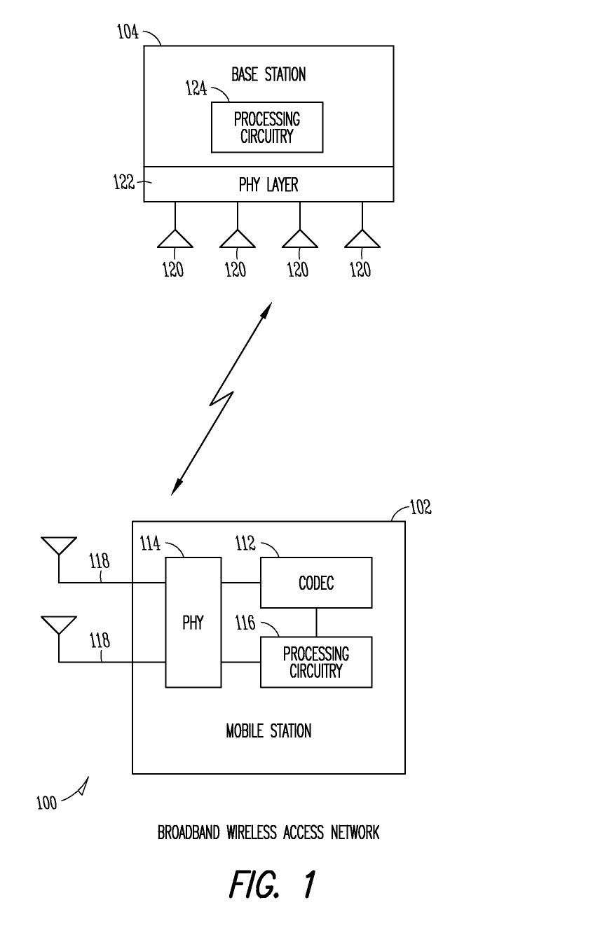

FIG. 1 illustrates a portion of a broadband wireless access network 100 in accordance some embodiments. Broadband wireless access network 100 includes a mobile station 102 and a base station 104. The mobile station 102 includes, among other things, a voice codec 112, physical (PHY) layer circuitry 114, and processing circuitry 116. The processing circuitry 116 may be part of a media-access control (MAC) layer circuitry. For VoIP communications, the voice codec 112 may generate voice packets for uplink transmission to the base station 104 using the PHY layer circuitry 114, and voice packets may be received from the base station 104 through PHY layer circuitry 114 for processing by voice codec 112. The processing circuitry 116 may control the operations of PHY layer circuitry 114 and voice codec 112 and perform adaptive granting and polling operations for the mobile station 102, as described in more detail below. The base station 104 includes physical layer circuitry 122 and processing circuitry 124 for performing operations and communicating with one or more mobile stations, such as the mobile station 102. Processing circuitry 124 also performs adaptive granting and polling operations for the base station 104, as described in more detail below. The mobile station 102 may unitize one or more antennas 118 for communicating with the base station 104, and the base station 104 may utilize one or more antennas 120 for communicating with the mobile station 102. In some multiple-input multiple-output (MIMO) embodiments, the mobile station 102 may utilize two or more of antennas 118 and the base station 104 may utilize two or more of antennas 120. Some embodiments may be implemented using single-input single-output (SISO) architectures.

In some embodiments, the broadband wireless access network 100 may be a Worldwide Interoperability for Microwave Access (WiMAX) network and the mobile station 102 and the base station 104 may be WiMAX communication devices, although the scope of the embodiments is not limited in this respect. In these embodiments, the mobile station 102 and the base station 104 may communicate in accordance with one of the IEEE 802.16 communication standards.

In accordance with some embodiments, during VoIP communications, the mobile station 102 and the base station 104 may implement an adaptive granting and polling service. In these embodiments, the mobile station 102 may detect a voice-state transition and may provide an indication to the base station 104 to change a grant interval based on the detected voice-state transition. The base station 104 may dynamically adapt the grant interval based on the indication. In these embodiments, the voice-state transition is detected prior to grant adaptation. In some embodiments, the voice-state transition may be detected by the voice codec 112 or by the PHY layer circuitry 114.

Unlike some conventional techniques that utilize an extended real-time polling service (ertPS), embodiments disclosed herein may utilize an adaptive granting and polling (aGP) service that dynamically adapts the grant interval based on the detected voice-state transition. In some embodiments, in response to detecting a voice-state transition, a change indicator may be set to indicate to the base station 104 to change a grant-polling interval (GPI) value. The change indicator may be provided in either a bandwidth request (BR) header or a grant management subheader, although this is not a requirement.

In some embodiments, the adaptive granting and polling service may be an aGP service, in accordance with an IEEE 802.16m standard. In some embodiments, setting the change indicator may comprise setting a quality-of-service change indicator (QPICI). In some embodiments, setting the change indicator may comprise setting a quality-of-service (QoS) parameter set switch (QPSS) field. The QPSS field may be provided in either a bandwidth request header or a grant management subheader. In some IEEE 802.16m embodiments, the QPSS field may be provided to indicate a change in the GPI value.

In some alternate embodiments, setting the change indicator includes setting either an unsolicited grant interval change indicator (UGICI) or a grant-polling interval change indicator (GPICI) to indicate to the base station 104 to change an unsolicited grant interval (UGI) value.

In some other embodiments, rather than providing an explicit indication to the base station 104 to change the grant interval, the grant interval may be adapted implicitly. In these implicit grant interval adaption embodiments, the base station 104 may change the grant interval automatically in response to the detection or certain traffic conditions. These implicit grant interval adaption embodiments may be in accordance one of the IEEE 802.16 standards and are described in more detail below.

In some embodiments, the mobile station 102 and the base station 104 may be configured to communicate orthogonal frequency division multiplexed (OFDM) communication signals over a multicarrier communication channel. The OFDM signals may comprise a plurality of orthogonal subcarriers. In some broadband multicarrier embodiments, the mobile station 102 and the base station 104 may be broadband wireless access (BWA) network communication stations, such as WiMAX communication stations. In some other broadband multicarrier embodiments, the mobile station 102 and the base station 104 may be 3rd Generation Partnership Project (3GPP) Universal Terrestrial Radio Access Network (UTRAN) Long-Term-Evolution (LTE) communication stations, although the scope of the embodiments is not limited in this respect. In these broadband multicarrier embodiments, the mobile station 102 and the base station 104 may be configured to communicate in accordance with an orthogonal frequency division multiple access (OFDMA) technique.

Some embodiments may utilize multi-carrier code division multiple access (MC-CDMA), multi-carrier direct-sequence code division multiple access (MC-DS-CDMA) or other modulation/multiplexing scheme compatible with the features of the inventive embodiments.

In some embodiments, the mobile station 102 may be a portable wireless communication device, such as a personal digital assistant (PDA), a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

Antennas 118 and 120 may comprise one or more directional or omnidirectional antennas, including, for example, dipole antennas, monopole antennas, patch antennas, loop antennas, microstrip antennas or other types of antennas suitable for transmission of radio-frequency (RF) signals. In some embodiments, instead of two or more antennas, a single antenna with multiple apertures may be used. In these embodiments, each aperture may be considered a separate antenna. In some MIMO embodiments, antennas 118 (as well as antennas 120) may be effectively separated to utilize the spatial diversity of the different spatial channels.

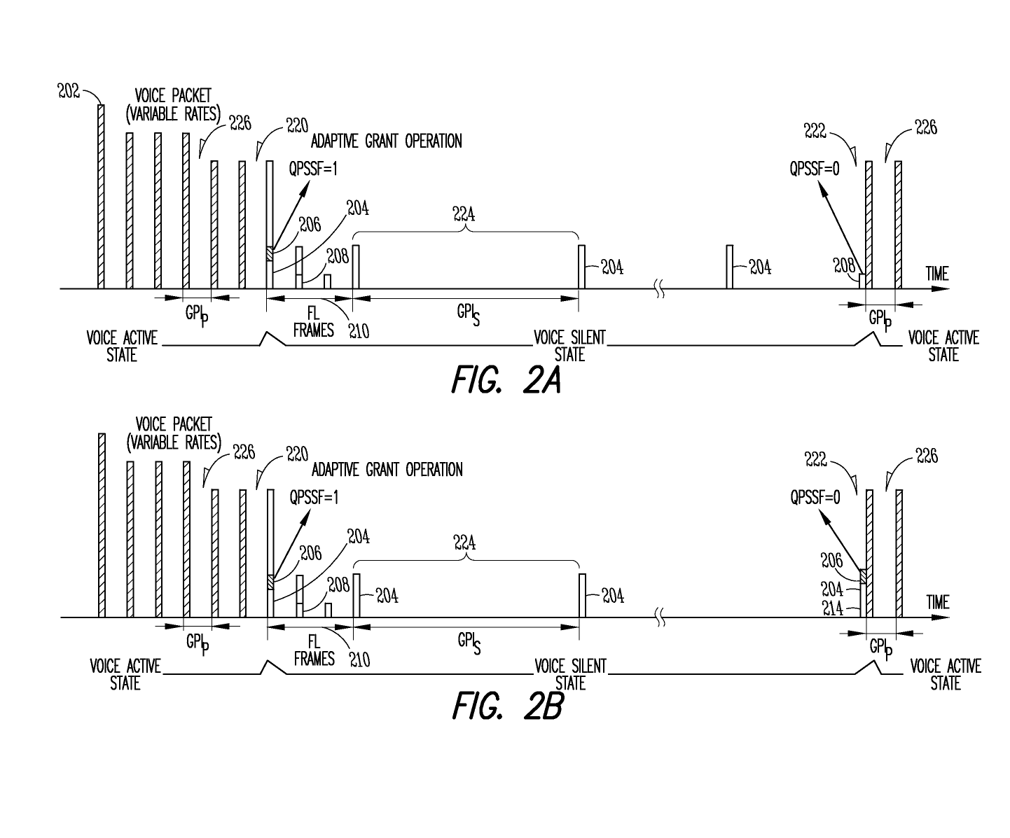

FIGS. 2A and 2B illustrate adaptive grant operation, in accordance with some embodiments. Voice packets 202 may be transmitted from the mobile station 102 (FIG. 1) to base station 104 (FIG. 1) during uplink bandwidth allocations. Voice packets 202 of variable rates may be provided by the voice codec 112 (FIG. 1). During the voice-active states, voice packets 202 may be generated periodically. During the voice-silent states, silence information description (SID) packets 204 may be generated at times depending on the particular voice codec 112.

One issue with conventional systems is that during voice-silent states, the base station 104 allocates uplink bandwidth grants to the mobile station 102 (e.g., for a bandwidth requested header) even though the mobile station 102 may not have a voice packet to send. In accordance with embodiments, one-bit signaling is incorporated into the bandwidth request header and/or the grant management subheader to indicate the voice state. A voice-state transition may be detected and an indication may be provided to the base station 104 to change a grant interval based on the detected voice-state transition. In some embodiments, a change indicator may be provided to the base station 104 to change the GPI value. The change indicator may be provided in either a bandwidth request header 208 or a grant management subheader 206. Accordingly, wasted grants may be reduced.

In some embodiments, in response to detecting a voice-state transition 220 from a voice-active state to a voice-silent state, the QPSS field may be set to indicate to the base station 104 to change the GPI value from a GPI primary value (GPIₚ) 226 to a GPI secondary value (GPIₛ) 224. In response to detecting a voice-state transition 222 from the voice-silent state to the voice-active state, the QPSS field may be set to indicate to the base station 104 to change the GPI value from the GPI secondary value 224 to the GPI primary value 226. In these embodiments, the QPSS field may be set to one, for example, to indicate to the base station 104 to change the GPI value from the GPI primary value 226 to the GPI secondary value 224. The QPSS field may be set to zero, for example, to indicate to the base station 104 to change the GPI value from the GPI secondary value 224 to the GPI primary value 226.

In FIG. 2A, when a voice-state transition 222 from the voice-silent state to the voice-active state is detected, the mobile station 102 may use a contention-based mechanism to provide the QPSS field to the base station 104 because the mobile station 102 does not have bandwidth allocation. In FIG. 2B, when a voice-state transition 222 from the voice-silent state to the voice-active state is detected, the mobile station 102 may piggyback the QPSS field in a grant management subheader 206 since the mobile station 102 has a bandwidth allocation (i.e., SID packet 214).

In some embodiments, in response to detecting a voice-state transition 220 from the voice-active state to the voice-silent state, a parameter change indicator may be set to indicate to the base station 104 to change the GPI value to a new GPI value. The new GPI value may be indicated by a running GPI field in a service-specific bandwidth request header. In response to detecting a voice-state transition 222 from the voice-silent state to the voice-active state, the parameter change indicator may be set to indicate to the base station 104 to change the GPI value to a running GPI value. The running GPI value may be indicated in the running GPI field in at least one of the service-specific bandwidth request headers. In some embodiments, the parameter change indicator may be a bit in at least one of an extended piggyback request field of a grant management subheader 206 or a bandwidth request header of one or more media-access control (MAC) signaling headers.

In some embodiments, the parameter change indicator comprises a QoS parameter change indicator (QPCI). The least-significant bits (LSBs) of a running GPI field in the service-specific bandwidth request header may be used to define the new GPI value or to provide the running GPI value. In some IEEE 802.16m embodiments, the parameter change indicator may comprises a QPCI, although the scope of the embodiments is not limited in this respect.

In some embodiments, when more than one grant interval is associated with a voice-silent state, the running GPI field may be used by the mobile station 102 to indicate to the base station 104 to dynamically change the running GPI to the new GPI value. The GPI primary value, the GPI secondary value and the running GPI value may be selected based on the particular voice codec 112 of the mobile station 102 and based on a tradeoff between capacity and delay. These embodiments are described in more detail below.

In some embodiments, when the change indicator (e.g., in the QPSS field) is set (e.g., to zero) to indicate a voice-state transition 220 from a voice-active state to a voice-silent state, the mobile station 102 may indicate to the base station 104 to change a grant size to a specified grant size. When the change indicator (e.g., in the QPSS field) is set (e.g., to one) to indicate a voice-state transition 220 to a voice-active state from a voice-silent state, the base station 104 may change the grant size to a minimum reserved traffic rate. The specified grant size may be specified in the bandwidth request field of a MAC signaling header or grant management subheader.

When the change indicator (e.g., in the QPSS field) is set (e.g., to zero) to indicate a voice-state transition 220 from a voice-active state to a voice-silent state, the base station 104 may schedule uplink grants for the mobile station 102 in accordance with the GPI secondary value for voice-silent state operations. When the change indicator (e.g., in the QPSS field) is set (e.g., to one) to indicate a voice-state transition 220 to a voice-active state from a voice-silent state, the base station 104 may schedule uplink grants for the mobile station 102 in accordance with the GPI primary value for voice-active state operations. In some embodiments, the GPI secondary value may be provided to the base station 104 in the running GPI field.

The GPI primary value may define a nominal time interval between successive data grant opportunities during the voice-active state. The GPI secondary value may define a nominal time interval between successive data grant opportunities during the voice-silent state.

In these embodiments, the GPI secondary value may be changed, and different GPI secondary values may be used and provided to the base station 104 at different times. In some embodiments, the GPI primary value may be a minimum GPI value and the GPI secondary value may be a maximum GPI value. In some embodiments, the GPI primary value may range between approximately 15 and 25 milliseconds. The GPI secondary value may range from three to eight or more times the GPI primary value, although the scope of the embodiments is not limited in this respect.

In some embodiments, the GPI secondary value may be selected to be the nominal time-interval between two adjacent SID packets 204. In some embodiments, the GPI secondary value may be selected based on a minimum discontinuous transmission (DTX) update of a voice codec 112 of the mobile station 102. In some embodiments, the GPI secondary value may be determined by the base station 104 based on the minimum DTX update of the particular voice codec 112 of the mobile station 102, although this is not a requirement. In some embodiments, the GPI primary value and the GPI secondary value are established during service flow creation, although this is not a requirement, as the GPI secondary value may be determined during the service flow (e.g., VoIP).

In some embodiments, the GPI primary value and GPI secondary values may be an integral number of one or more frame durations (e.g., such as WiMAX frame durations), and the mobile station 102 and the base station 104 may be WiMAX communication stations that communicate VoIP packets in accordance with one of the IEEE 802.16 standards. Each WiMAX frame may have a duration of five milliseconds, although the scope of the embodiments is not limited in this respect.

In some alternate embodiments, in response to detecting a voice-state transition 220 from the voice-active state to the voice-silent state, the mobile station 102 may send one or more zero-sized bandwidth requests to indicate to the base station 104 to change the GPI value from the GPI primary value 226 to the GPI secondary value 224. In response to detecting a voice-state transition 222 from the voice-silent state to the voice-active state, the mobile station 102 may send one or more non-zero sized bandwidth requests to indicate to the base station to change the GPI value from the GPI secondary value to the GPI primary value. In these alternate embodiments, an implicit approach to changing the GPI value is provided. The GPI value may be changed to an implicit value rather than an explicitly identified value.

Conventionally, a UGI value is conveyed in Dynamic Service Flow Addition (DSA) or Dynamic Service Flow Change (DSC) MAC management messages between a mobile station and a base station. The type of type/length/value (TLV) for the UGI in a DSA/DSC message is type 40. In some embodiments, the type 40 UGI TLV may be changed for the GPI primary value and another type TLV may be used for GPI secondary value. In these embodiments, an adaptive grant scheduling class decodes the other type TLV as the GPI secondary value and uses the type 40 TLV as the GPI primary value. In some embodiments, a type 47 TLV maybe used for the GPI secondary value, although this is not a requirement. A format other than a TLV format may alternatively be used. These embodiments are backward compatible with conventional techniques since the existing ertPS scheduling class discards the type 47 TLV and uses the type 40 TLV as the conventional UGI value.

In accordance with some embodiments, the GPI primary value may specify the nominal interval between successive data grant opportunities for the service flow in the voice-active state when the scheduling class is an adaptive grant scheduling class. A schedule for enforcing this parameter may be defined by a reference time t₀, with the desired transmission time tᵢ=t₀+i×interval. The actual grant time t′ᵢ may be in the range tᵢ<=t′ᵢ<=tᵢ+jitter. The interval is the value specified with the TLV, and the jitter may be the tolerated jitter. An example of this TLV is illustrated in Table 1.

TABLE 1

| Type | Length | Value | Scope |
|---|---|---|---|
| [145/146].40 | 2 | ms | DSA-REQ, |
| | | | DSA-RSP, |
| | | | DSC-REQ, |
| | | | DSC-RSP |

In some embodiments, the DSA-REQ, the DSA-RSP, the DSC-REQ and the DSC-RSP messages may be advanced DSA and DSC request and response messages, referred to as ADSA-REQ, ADSA-RSP, ADSC-REQ and ADSC-RSP messages.

In accordance with some embodiments, the GPI secondary value may specify the nominal interval between successive data grant opportunities for the service flow in voice-silent state when the scheduling class is the adaptive grant scheduling class. A schedule for enforcing this parameter may be defined by a reference time t₀, with the desired transmission time tᵢ=t₀+i×interval. The actual grant time, t′ᵢ may be in the range tᵢ<=t′ᵢ<=tᵢ+jitter. The interval is the value specified with this TLV, and the jitter may be the tolerated jitter. An example of this TLV is illustrated in Table 2.

TABLE 2

| Type | Length | Value | Scope |
|---|---|---|---|
| [145/146].x | 2 | ms | DSA-REQ, |
| | | | DSA-RSP, |
| | | | DSC-REQ, |
| | | | DSC-RSP |

In some embodiments, the GPI secondary value may be signaled in real time in a grant management subheader and/or MAC signaling headers type I. In these embodiments, alternatively or in addition to signaling the GPI primary value and the GPI secondary value during service flow creation or service flow changes, a conventional UGI may be used as the GPI primary value. The GPI secondary value may be signaled in real time in the grant management subheader and in the MAC signaling headers type I. Signaling the GPI secondary value in real time allows the grant interval to be adaptive, particularly to the variable DTX update intervals in a G.729 voice codec or to the first two SIDs provided by an AMR voice codec. Signaling the GPI secondary value in real time allows the GPI value to be applied to other real time applications, such as online gaming and push to talk (PTT) as discussed below, although the scope of the embodiments is not limited in this respect.

In some embodiments, an extended piggyback request field in the grant management subheader may be used as shown in Table 3. The bandwidth request field in the MAC signaling headers type I may be used as shown in Table 4. The QPSS field referenced in the Tables 3 and 4 may comprise one-bit that is added to signal voice state. The length of the fields may be reduced from 11 bits to 10 bits.

TABLE 3

| Name | Size | Description |
|---|---|---|
| . . . | | |
| Extended | 10 bits | If the QPSS field is zero, the base station changes its |
| piggyback | | grant size to the size specified in this field, and |
| request | | changes its grant interval to GPI_{P}. |
| | | Else if the QPSS field is one, the base station |
| | | changes its grant size to Minimum Reserved Traffic |
| | | Rate, and changes its grant interval to GPI_{S}. |
| . . . | | |

Table 4 shows a bandwidth request field suitable for use for the MAC signaling headers including a bandwidth request and uplink (UL) transmit (Tx) power report header, a bandwidth request and carrier to interference plus noise (CINR) report header and a bandwidth control and uplink sleep control header.

TABLE 4

| Name | Size | Description |
|---|---|---|
| . . . | | |
| BR | 10 bits | If QPSS field is zero, the base station changes its grant |
| | | size to the size specified in this field, and changes its |
| | | grant interval to GPI_{P}. |
| | | Else if QPSS field is one, the base station changes its |
| | | grant size to Minimum Reserved Traffic Rate, and |
| | | changes its grant interval to GPI_{S}. |
| . . . | | |

In some embodiments, the grant interval may be dynamically changed during a voice conversation. In these embodiments, grant adaptation may be triggered either implicitly or explicitly. In the implicit approach, the grant interval switches between two values (e.g., GPI_{P} and GPI_{S}) signaled in the service flow creation/change management messages. In the explicit approach, explicit signaling is utilized and the grant interval value may be dynamically changed to multiple values. The grant interval value may be explicitly indicted by the running GPI field of the Service Specific BR.

In the implicit approach, the grant adaptation from the GPI primary value to the GPI secondary value may be triggered implicitly when the base station 104 (FIG. 1) receives a predetermined (e.g., the N^{th}) zero-sized bandwidth request from the mobile station 102. The grant adaptation from the GPI secondary value to the GPI primary value may be triggered implicitly when the base station 104 receives a non-zero sized bandwidth request from the mobile station 102.

In the explicit approach, a one-bit change indication field, such as the QPSS field, may be added in the grant management subheader and the MAC signaling header type I to indicate the change of the GPI for the adaptive grant scheduling class. In these embodiments, when the QPSS field is zero, the GPI primary value may be used for the adaptive grant interval. When the QPSS field is one, the GPI secondary value may be for adaptive grant interval.

In some embodiments, the one-bit QPSS field may be added and the size of an extended piggyback request may be reduced from 11 bits to 10 bits. Table describes a grant management subheader format for these adaptive grant operations The change of the grant interval may take effect after the number of frames 210 (FIG. 2) when frame latency (FL) is enabled as indicated by a frame latency (FL) indicator (FLI). When the FLI indicates that FL is not enabled, the change of the GPI may become valid immediately.

TABLE 5

| Syntax | Size | Notes |
|---|---|---|
| grant management | — | — |
| subheader { | | |
| . . . | | |
| if (scheduling service | | |
| type == adaptive grant){ | | |
| Extended piggyback | 10 bits | |
| request | | |
| QPSS field | 1 bit | If QPSS field is zero, GPIp shall be |
| | | used for adaptive grant interval; if |
| | | QPSS field is one, GPIs shall be used |
| | | for adaptive grant interval. |
| FLI | 1 bit | |
| FL | 4 bits | The number of frames after which |
| | | this grant will take effect |
| } | | |
| . . . | | |

In some embodiments, an explicit indication of the GPI change may be provided in the MAC signaling header Type 1. In these embodiments, a one-bit QPSS field may be added and the bandwidth request size may be reduced from 19-bits to 18-bits when a standalone bandwidth request header is used. Examples of some service-specific bandwidth request headers are illustrated in FIGS. 3A and 3B.

In the service-specific bandwidth request header illustrated in FIG. 3A, when the QPICI is set to zero, the QPSS field is used to toggle between the GPI primary value and the GPI secondary value. In the service-specific bandwidth request header illustrated in FIG. 3B, when the QPICI is set to one, the new GPI value may be specified in the GPI running field.

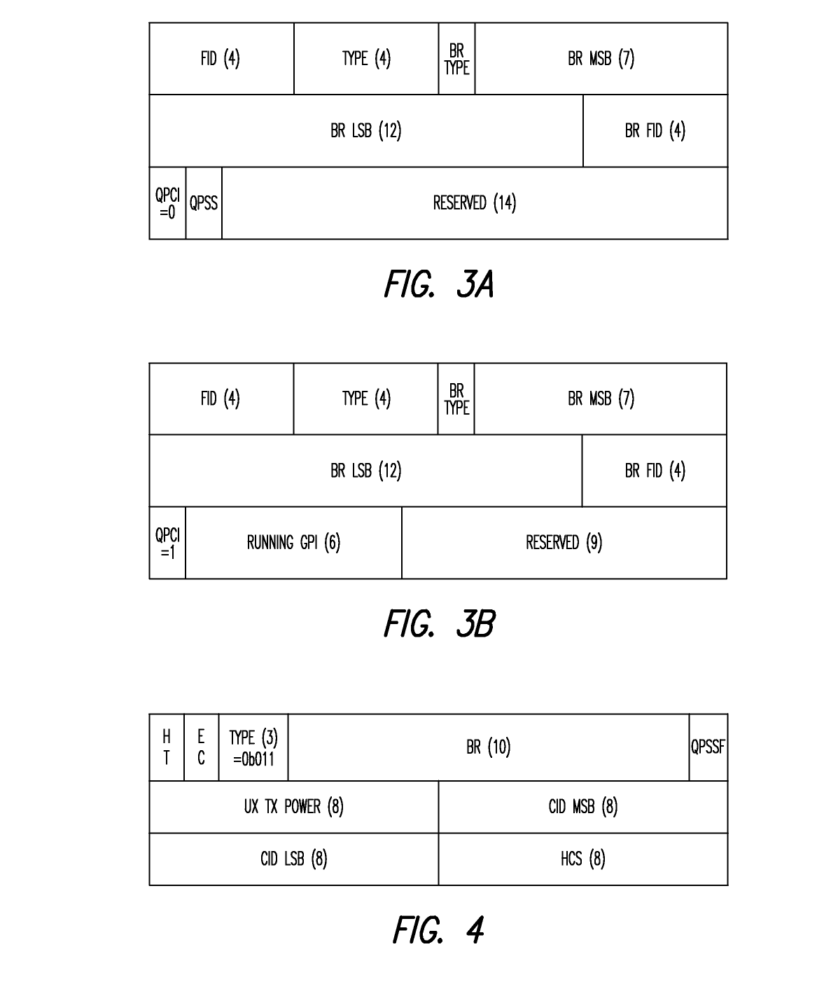

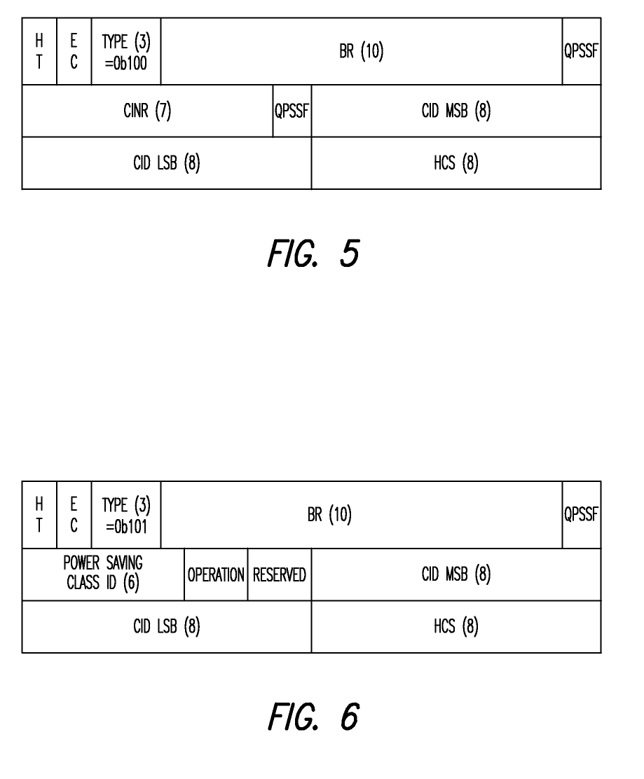

The bandwidth request size may be reduced from 11-bits to 10-bits when the indication is included in the Bandwidth Request and a UL Tx Power Report Header. An example of this bandwidth request header is illustrated in FIG. 4. The bandwidth request size may be reduced from 11-bits to 10-bits when the indication is included in the Bandwidth Request and CINR Report Header. An example of this bandwidth request header is illustrated in FIG. 5. The bandwidth request size may be reduced from 11-bits to 10-bits when the indication is included in a Bandwidth Request and Uplink Sleep Control Header. An example of this bandwidth request header is illustrated in FIG. 6. Unlike a request sent in the grant management subheader when FLI is enabled, the change of the GPI may become valid immediately.

Referring back to FIG. 2A, upon detection of a voice-state transition 220 from the voice-active state to the voice-silent state, the mobile station 102 may signal the change of the GPI to the GPI secondary value by sending several zero sized bandwidth requests or setting the QPSS field to one in the grant management subheader or MAC signaling header Type I for an adaptive grant. Once the base station 104 receives the grant management subheader or the MAC signaling header type I for adaptive grant, it may schedule the grants according to the QPSS field. In the example shown in FIG. 2A, the grant management subheader is used to convey the QPSS field. The QPSS field is set to one to indicate the change of GPI to the GPI secondary value. The FLI is enabled so that the GPI change takes effect after the FL frames 210.

Upon detection of the voice-state transition 222 from the voice-silent state to the voice-active state, the mobile station 102 may signal the change of the GPI to the GPI primary value by sending a non-zero sized bandwidth request or by setting the QPSS field to zero in the grant management subheader or the MAC signaling header type I for adaptive grant operations. The mobile station 102 may also signal the change of the GPI to the GPI primary value by sending a codeword (such as 0b111011) over an information channel such as a channel quality information channel (CQICH) or a primary feedback channel in accordance with the IEEE 802.16m standard. When a unicast bandwidth request opportunity is not available, the mobile station 102 may use contention request opportunities to inform the base station 104 that it has data to send. Once the base station 104 receives the grant management subheader, the MAC signaling header, or the codeword over the information channel, the base station 104 may schedule grants according to the QPSS field. FIG. 2B illustrates the use of contention request opportunities by the mobile station 102 to inform the base station 104 that it has data to send. The base station 104 may allocate a 6 byte grant for the mobile station 102 to send the bandwidth request header. The mobile station 102 may then set the QPSS field to zero in the bandwidth request header to indicate the change of the GPI to the GPI primary value in addition to requesting larger grants for voice packets. The base station 104 may allocate the grants for the voice packets with the new grant interval set to the GPI primary value.

FIG. 2B also illustrates another opportunity for the mobile station 102 to convey the QPSS field to the base station 104. When a voice packet received from a higher layer is immediately followed by an uplink grant allocated for the SID packet size, the mobile station 102 may send the request to immediately change the GPI to the GPI primary value in the grant management subheader 206 associated with that grant. The base station 104 may then allocate a grant for the voice packets with the new grant interval set to the GPI primary value.

As discussed above, in some embodiments different GPI values may be selected depending on the particular voice codec 112. As illustrated in FIGS. 2A and 2B, the voice codec 112 (FIG. 1) generates SID packets 204 during the voice-silent state periodically. For this type of voice codec (such as an adaptive multi-rate (AMR) codec), the GPI values may be selected as a constant time period between two adjacent SID frames after a few of the initial frames.

For a voice codec that generates SID frames in a different pattern than in AMR codec during the voice-silent state, GPI values may be selected to be the minimum DTX update interval that the codec supports. For example, an ITU G.729b codec supports a minimum DTX update interval of 3T, and a GPI value of 3T may be selected for that codec. For an EVRC-B codec, the GPI values shall be chosen as the minimum DTX update interval specified for that codec. A default value is 12T for an EVRC-B codec. In some embodiments, T may equal 20 milliseconds.

In accordance with the embodiments discussed above, uplink bandwidth grants wasted during the voice-silent state for silence-suppressed VoIP traffic may be reduced and, therefore, less uplink bandwidth may be consumed by adapting the grant interval to the actual voice frame duration in accordance with the GPI primary value and the GPI secondary value. Accordingly, the network's VoIP capacity may be increased. Some embodiments described above may provide an uplink bandwidth decrease and VoIP capacity improvements over the use of ertPS. For example, the uplink bandwidth usage may be decreased in the range of 11%-31% and the capacity may be increased in the range of 12%-46%, depending on the codec type, the IP version, and whether or not header suppression is enabled. For example, for AMR codec using IPv4 with header suppression, the uplink bandwidth usage may be decreased from 18.5% (using the highest rate) to 25% (using the lowest rate).

Some embodiments may also be suitable for use when a persistent scheduling technique is used to schedule VoIP packets. Persistent scheduling is a technique which can reduce the control overhead for scheduling VoIP transmissions. In a persistent scheduling technique, resources are allocated persistently to every VoIP user for multiple frames. The control information specifying this allocation information is sent in the first frame and skipped in subsequent frames. In order to allocate resources persistently, it is important to know when the voice-active states and the voice-silent states start and the period with which to allocate resources. Embodiments disclosed herein may be applied to persistent scheduling techniques by indicating when a voice-active state occurs and when a voice-silent state occurs.

An apparatus for use in a wireless network may include a processing circuit including logic (e.g., circuitry, processor and software, or combination thereof) to perform adaptive grant requests/interval grants as described in one or more of the processes above. In certain non-limiting embodiments, apparatus may generally include a RF interface and a MAC/baseband processor portion. In one example embodiment, the RF interface may be any component or combination of components adapted to send and receive multi-carrier modulated signals (e.g., OFDMA), although the inventive embodiments are not limited to any specific over-the-air (OTA) interface or modulation scheme.

Some embodiments are applicable to online gaming. In these embodiments, a mobile station, such as mobile station 102 (FIG. 1) may be performing an online gaming application. These embodiments take into account the on/off properties of online gaming traffic when granting bandwidth. In these embodiments, the mobile station may detect state transitions between an active state and an inactive state (less active) of the online gaming uplink traffic. The mobile station may provide an indication to change a grant interval based on the detected state transition. In ways similar to the embodiments discussed above for VoIP communications, the grant interval is dynamically changed based on the indication.

The components and features of the apparatus may be implemented using any combination of discrete circuitry, application specific integrated circuits (ASICs), logic gates and/or single chip architectures. Further, the features of the apparatus may be implemented using microcontrollers, programmable logic arrays and/or microprocessors or any combination of the foregoing where suitably appropriate. It is noted that hardware, firmware and/or software elements may be collectively or individually referred to as “logic” or “circuit.”

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method performed by a mobile station during voice-over-internet protocol (VoIP) communications using an adaptive granting and polling service in a broadband wireless access network, the method comprising:
detecting a voice-state transition;
providing an indication to a base station to change a grant interval based on the detected voice-state transition,
wherein the mobile station communicates in accordance with the grant interval that is dynamically adapted based on the indication.

2. The method of claim 1, wherein in response to detecting a voice-state transition, the method comprises setting a change indicator field to indicate to the base station to change a grant-polling interval (GPI) value.

3. The method of claim 2, wherein the adaptive granting and polling service is an adaptive granting and polling (aGP) service in accordance with an IEEE 802.16m standard; and
wherein setting the change indicator field comprise a quality-of-service (QoS) parameter set switch (QPSS) field.

4. The method of claim 3, wherein in response to detecting a voice-state transition from a voice-active state to a voice-silent state, the method comprises setting the QPSS field to indicate to the base station to change the GPI value from a GPI primary value to a GPI secondary value, and
wherein in response to detecting a voice-state transition from the voice-silent state to the voice-active state, the method comprises setting the QPSS field to indicate to the base station to change the GPI value from the GPI secondary value to the GPI primary value.

5. The method of claim 2, wherein in response to detecting a voice-state transition from a voice-active state to a voice-silent state, the method comprises setting a parameter change indicator to indicate to the base station to change the GPI value to a new GPI value, the new GPI value being indicated by a running GPI field in a service-specific bandwidth request header; and
wherein in response to detecting a voice-state transition from the voice-silent state to the voice-active state, the method comprises setting the parameter change indicator to indicate to the base station to change the GPI value to a running GPI value, the running GPI value being indicated in the running GPI field in at least one of the service-specific bandwidth request headers.

6. The method of claim 5, wherein the parameter change indicator comprises a QoS parameter change indicator (QPCI).

7. The method of claim 2, wherein when the change indicator field is set to indicate a voice-state transition from a voice-active state to a voice-silent state, the method includes indicating to the base station to change a grant size to a specified grant size; and
when the change indicator field is set to indicate a voice-state transition to a voice-active state from a voice-silent state, the base station is to change the grant size to a minimum reserved traffic rate.

8. The method of claim 7, wherein the specified grant size is specified in least-significant bits of a grant management subheader field or a bandwidth request field of a media-access control signaling header.

9. The method of claim 2, wherein when the change indicator field is set to indicate a voice-state transition from a voice-active state to a voice-silent state, the base station is to schedule uplink grants for the mobile station in accordance with a GPI secondary value for voice-silent state operations,
wherein when the change indicator field is set to indicate a voice-state transition to a voice-active state from a voice-silent state, the base station is to schedule uplink grants for the mobile station in accordance with a GPI primary value for voice-active state operations,
wherein the GPI primary value defines a nominal time interval between successive data grant opportunities during the voice-active state,
wherein the GPI secondary value defines a nominal time interval between successive data grant opportunities during the voice-silent state; and
wherein the method further comprises providing the GPI secondary value to the base station in a running GPI field.

10. The method of claim 9, wherein the GPI secondary value is selected to be the nominal time-interval between two adjacent silence-information description packets.

11. The method of claim 9, wherein the GPI secondary value is selected based on a minimum discontinuous transmission (DTX) update of a codec of the mobile station.

12. The method of claim 9, wherein the GPI primary value and the GPI secondary value are established during service flow creation.

13. The method of claim 1, wherein in response to detecting a voice-state transition from a voice-active state to a voice-silent state, the method comprises sending one or more zero-sized bandwidth requests to indicate to the base station to change a grant-polling interval (GPI) value from a GPI primary value to a GPI secondary value; and
wherein in response to detecting a voice-state transition from the voice-silent state to the voice-active state, the method comprises sending one or more non-zero sized bandwidth requests to indicate to the base station to change the GPI value from the GPI secondary value to the GPI primary value.

14. A mobile station to communicate using an adaptive granting and polling service during voice-over-internet protocol (VoIP) communications, the mobile station comprising:
a codec to detect a voice-state transition; and
network interface circuitry to provide an indication to a base station to change a grant interval based on the detected voice-state transition,
wherein the mobile station communicates in accordance with the grant interval that is dynamically adapted based on the indication.

15. The mobile station of claim 14, wherein in response to detecting a voice-state transition, the mobile station is to set a change indicator field to indicate to the base station to change a grant-polling interval (GPI) value.

16. The mobile station of claim 15, wherein in response to detecting a voice-state transition from a voice-active state to a voice-silent state, the mobile station sets the change indicator field to indicate to the base station to change the GPI value from a GPI primary value to a GPI secondary value; and
wherein in response to detecting a voice-state transition from the voice-silent state to the voice-active state, the mobile station sets the change indicator field to indicate to the base station to change the GPI value from the GPI secondary value to the GPI primary value.

17. The mobile station of claim 15, wherein the adaptive granting and polling service is an adaptive granting and polling (aGP) service in accordance with an IEEE 802.16m standard; and
wherein the change indicator field comprises a quality-of-service (QoS) parameter set switch (QPSS) field.

18. The mobile station of claim 15, wherein in response to detecting a voice-state transition from a voice-active state to a voice-silent state, the mobile station is to set a parameter change indicator to indicate to the base station to change the GPI value to a new GPI value, the new GPI value being indicated by a running GPI field in a service-specific bandwidth request header; and
wherein in response to detecting a voice-state transition from the voice-silent state to the voice-active state, the mobile station is to set the parameter change indicator to indicate to the base station to change the GPI value to a running GPI value, the running GPI value being indicated in the running GPI field in at least one of the service-specific bandwidth request headers.

19. The mobile station of claim 15, wherein when the change indicator field is set to indicate a voice-state transition from a voice-active state to a voice-silent state, the mobile station indicates to the base station to change a grant size to a specified grant size; and
when the change indicator field is set to indicate a voice-state transition to a voice-active state from a voice-silent state, the base station is to change the grant size to a minimum reserved traffic rate.

20. The mobile station of claim 14, wherein in response to detecting a voice-state transition from a voice-active state to a voice-silent state, the mobile station is to send one or more zero-sized bandwidth requests to indicate to the base station to change a grant-polling interval (GPI) value from a GPI primary value to a GPI secondary value, and
wherein in response to detecting a voice-state transition from the voice-silent state to the voice-active state, the mobile station is to send one or more non-zero sized bandwidth requests to indicate to the base station to change the GPI value from the GPI secondary value to the GPI primary value.

21. A method for allocating bandwidth requests comprising:
changing a grant interval based on a voice-state transition; and
setting the grant interval to either a predetermined value or to a provided value.

22. The method of claim 21, wherein in response to detecting a voice-state transition from a voice-active state to a voice-silent state, the method comprises sending one or more zero-sized bandwidth requests to indicate to the base station to change a grant-polling interval (GPI) value from a GPI primary value to a GPI secondary value; and
wherein in response to detecting a voice-state transition from the voice-silent state to the voice-active state, the method comprises sending one or more non-zero sized bandwidth requests to indicate to the base station to change the GPI value from the GPI secondary value to the GPI primary value.

23. The method of claim 21, wherein in response to detecting a voice-state transition, the method comprises setting a change indicator field to indicate to the base station to change a grant-polling interval (GPI) value,
wherein in response to detecting a voice-state transition from a voice-active state to a voice-silent state, the method comprises setting a parameter change indicator to indicate to the base station to change the GPI value to a new GPI value, the new GPI value being indicated by a running GPI field in a service-specific bandwidth request header; and
wherein in response to detecting a voice-state transition from the voice-silent state to the voice-active state, the method comprises setting the parameter change indicator to indicate to the base station to change the GPI value to a running GPI value, the running GPI value being indicated in the running GPI field in at least one of the service-specific bandwidth request headers.

24. The method of claim 21, wherein in response to detecting a voice-state transition, the method comprises setting a change indicator field to indicate to the base station to change a grant-polling interval (GPI) value,
wherein when the change indicator field is set to indicate a voice-state transition from a voice-active state to a voice-silent state, the method includes indicating to the base station to change a grant size to a specified grant size; and
when the change indicator field is set to indicate a voice-state transition to a voice-active state from a voice-silent state, the base station is to change the grant size to a minimum reserved traffic rate.

25. A method performed during on-line gaming in a broadband wireless access network, the method comprising:
detecting state transitions between an active state and an inactive state of on-line gaming traffic over an uplink;
providing an indication to change a grant interval based on the detected state transition,
wherein the grant interval is dynamically changed based on the indication.

26. The method of claim 25, wherein the method is performed by a mobile station, and
wherein the method further comprises:
upon detection of a state transition from the active state to the inactive state, setting a parameter change indicator to indicate to a base station to change a grant-polling interval (GPI) value to a new GPI value, the new GPI value being indicated by a running GPI field in a service-specific bandwidth request header; and
upon detection of a state transition from the inactive state to the active state, setting the parameter change indicator to indicate to the base station to change the GPI value to a running GPI value, the running GPI value being indicated in the running GPI field in at least one of the service-specific bandwidth request headers.

27. The method of claim 25, wherein in response to detecting a state transition, the method comprises setting a change indicator field to indicate to a base station to change a grant-polling interval (GPI) value,
wherein when the change indicator field is set to indicate a state transition from the active state to the inactive state, the method includes indicating to the base station to change a grant size to a specified grant size; and
when the change indicator field is set to indicate a state transition to the active state from the inactive state, the base station is to change the grant size to a minimum reserved traffic rate.
